(19) United States
(12) Patent Application Publication
(10) Pub. No.: US 2007/0258174 A1
(43) Pub. Date: Nov. 8, 2007

(54) LOAD DRIVING APPARATUS AND ELECTRIC APPLIANCE THEREWITH

(75) Inventors: Seiichi Yamamoto, Kyoto (JP); Takahiro Ota, Kyoto (JP)

Correspondence Address: FISH & RICHARDSON P.C., P.O. BOX 1022, MINNEAPOLIS, MN, 55440-1022, US

(73) Assignee: Rohm Co., Ltd., Kyoto (JP)

(21) Appl. No.: 11/743,799

(22) Filed: May 3, 2007

(30) Foreign Application Priority Data
May 8, 2006 (JP) 2006-129142

(51) Int. Cl. H02H 9/08

(52) U.S. Cl. 361/42

(57) ABSTRACT

A multiple-channel load driving apparatus has a plurality of driver circuits supplying drive currents individually to a plurality of loads. Of those driver circuits, at least one limits or stops the output thereof not only if an abnormality occurs in itself but also if an abnormality occurs in any other driver circuit. This configuration allows coordinated abnormality protection among the individual driver circuits, and thereby improves the safety and reliability of the load driving apparatus.

This application is based on Japanese Patent Application No. 2006-129142 filed on May 8, 2006, the contents of which are hereby incorporated by reference.

### BACKGROUND OF THE INVENTION

1. Field of the Invention

The present invention relates to a load driving apparatus provided with a plurality of drivers that supply drive currents individually to a plurality of loads, and also relates to an electric appliance (e.g., an optical disc drive apparatus) incorporating such a load driving apparatus.

2. Description of Related Art

Electric appliances incorporating an optical disc drive apparatus for playing back optical discs such as DVDs (digital versatile discs), CDs (compact discs), and MDs (minidiscs)—for example, car navigation systems, car audio systems, and portable navigation systems—include a motor driver IC for the driving of an optical disc. If some extraneous factor (e.g., deposited dust) causes an abnormality at an output terminal of such a motor driver IC, as by short-circuiting it to the supply voltage or to ground, an overcurrent exceeding the ASO (area of safe operation) of the motor driver IC may flow therethrough. This may lead to breakdown of the motor driver IC and, in the worst case, to smoking and flaming up.

To prevent this, various techniques have been disclosed and proposed for protecting a motor driver IC from an abnormality (see, e.g., JP-A-H5-252768 and JP-A-2005-020278).

JP-A-H5-252768 mentioned above discloses and proposes a heat protection circuit that shuts off the supply of current to a motor when the temperature around the motor rises while the motor is being supplied with current.

JP-A-2005-020278 mentioned above discloses and proposes a driving circuit that passes current from a first terminal thereof to a second through a load, the driving circuit comprising current detecting means for detecting the current flowing into the second terminal and current limiting means for limiting the output currents that upper transistors output via the two terminals respectively.

Certainly, applying the conventional protection techniques described above to a motor driver IC makes it possible to more effectively prevent breakdown of the IC, smoking, and flaming up even if an abnormality occurs at an output terminal of the IC.

However, the conventional protection techniques described above are supposed to protect a motor driver IC that drives a single motor, and are not supposed to protect a multiple-channel motor driver IC that supplies drive currents individually to a plurality of motors or actuators.

Thus, simply applying the conventional protection techniques described above to a multiple-channel motor driver IC may protect one driver circuit as soon as it suffers an abnormality, but does not protect any other until a given driver circuit itself actually suffers an abnormality. Thus, in a case where the cause that has caused an abnormality at an output of one driver circuit is of the nature that can readily cause a similar abnormality in another driver circuit, although the first occurrence of the abnormality predicts the following occurrences, the occasion for precautionary protection may be lost, resulting in too late protection for any following occurrence.

### SUMMARY OF THE INVENTION

An object of the present invention is to provide a load driving apparatus that is provided with a plurality of driver circuits for supplying drive currents individually to a plurality of loads but that nevertheless operates with improved safety and reliability as a result of coordinated protection against an abnormality among the individual driver circuits, and to provide an electric appliance (e.g., disc drive apparatus) incorporating such a load driving apparatus.

To achieve the above object, according to one aspect of the invention, in a multiple-channel load driving apparatus having a plurality of driver circuits supplying drive currents individually to a plurality of loads, at least one of those driver circuits limits or stops its output not only if an abnormality occurs in that driver circuit itself but also if an abnormality occurs in any other driver circuit.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a block diagram showing an optical disc drive apparatus, as an embodiment of the invention;

FIGS. 2A and 2B are block diagrams showing examples of the configuration of an abnormal protector 11a;

FIGS. 3A and 3B are block diagrams showing other examples of the configuration of an abnormal protector 11a; and

FIG. 4 is a circuit diagram showing a specific example of a ground-short protection circuit GSP1.

### DETAILED DESCRIPTION OF PREFERRED EMBODIMENTS

Hereinafter, the present invention will be described in detail by way of an example in which it is applied to a motor driver IC incorporated in an optical disc drive apparatus.

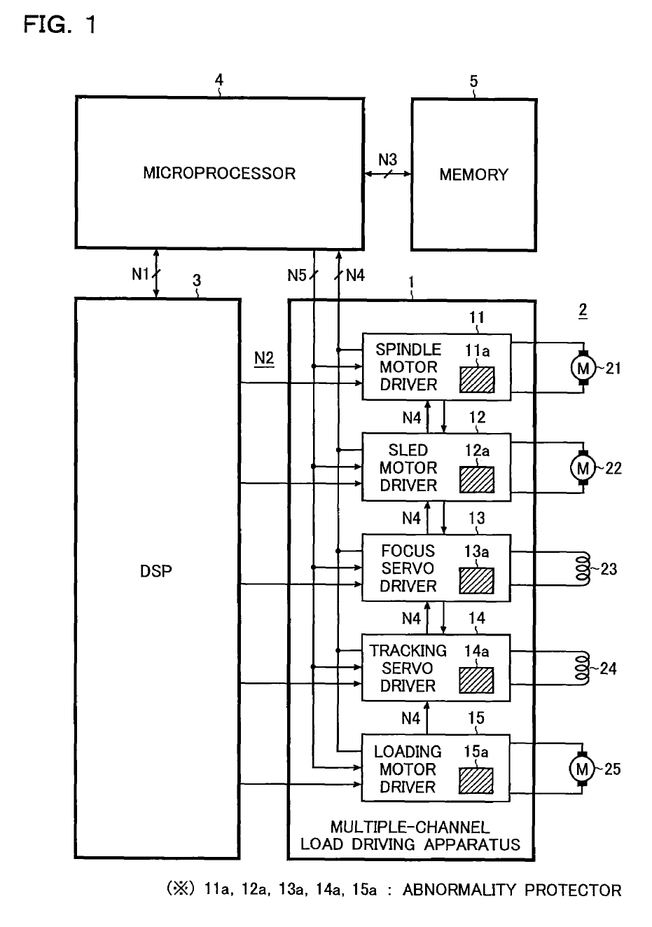

FIG. 1 is a block diagram showing an optical disc drive apparatus, as an embodiment of the invention.

As shown in FIG. 1, the optical disc drive apparatus of this embodiment includes a motor driver IC 1, a plurality of loads 2, a digital signal processor 3 (hereinafter “DSP 3”), a microprocessor 4, and a memory 5.

The motor driver IC 1 includes a spindle motor driver circuit 11, a sled motor driver circuit 12, a focus servo driver circuit 13, a tracking servo driver circuit 14, and a loading motor driver circuit 15, and is configured as a multiple-channel load driving apparatus that supplies drive currents individually to a plurality of loads 2 (a spindle motor 21, a sled motor 22, a focus servo coil 23, a tracking servo coil 24, and a loading motor 25) according to drive signals N2 from the DSP 3.

These driver circuits 11 to 15 are classified into two groups: to a first group belong the spindle motor driver circuit 11, the sled motor driver circuit 12, the focus servo driver circuit 13, and the tracking servo driver circuit 14, which are involved in the driving of an optical disc and of an optical pickup; to a second group belongs the loading motor driver circuit 15 alone, which is involved in the loading (and unloading) of an optical disc.

The second group may further include, for another example, a transport motor driver circuit for supplying a drive current to a transport motor for transporting an optical disc between a disc magazine case and a turn table in an optical disc drive apparatus furnished with a disc changer. In some optical disc drive apparatuses, a single motor is shared for the sledding of an optical pickup and for the loading (and unloading) of an optical disc; for example, the force from the shared single motor is first used to sled the optical pickup to the inner end of the optical disc, and is then used, via gears or the like, to actuate a loading mechanism to load the optical disc. In this case, the single motor is shared as both a sled motor and a loading motor, and is classified into the second group.

The driver circuits 11 to 15 are individually furnished with abnormality protectors 11a to 15a. If an abnormality occurs in any of the driver circuits 11 to 15, the corresponding one of the abnormality protectors 11a to 15a limits or stops the output of that driver circuit and then outputs an abnormality detection flag N4 to indicate the abnormal status. The configuration and operation of the abnormality protectors 11a to 15a will be described in detail later.

Among the loads 2, the spindle motor 21 drives a turn table (unillustrated), on which an optical disc is placed, to rotate at constant linear or rotation speed, as typically achieved with a brushed DC motor or three-phase brushless motor; the sled motor 22 drives an optical pickup (unillustrated) to move across the radius of the optical disc, as typically achieved with a brushed DC motor or two-phase brushless stepping motor; the focus servo coil 23 drives the objective lens of the optical pickup to move so as to control the focus of the beam spot formed on the optical disc; the tracking servo coil 24 drives the objective lens of the optical pickup to move so as to control the tracking of the beam spot formed on the optical disc; and the loading motor 25 drives a loading tray (unillustrated), on which the optical disc is placed, to move back and forth, as typically achieved with a brushed DC motor.

The DSP 3 feeds the drive signals N2 individually to the driver circuits 11 to 15 based on control signals N1 from the microprocessor 4.

The microprocessor 4 controls the operation of the different parts of the apparatus in a centralized fashion, performing many functions, of which those that deserve particular mentioning in connection with the present invention are: the feeding of the control signals N1 to the DSP 3; the monitoring of the abnormality detection flags N4 outputted from the motor driver IC 1; the storing and retrieval of abnormality history information N3 to and from the memory 5; and the feeding of shut-off signals N5 (or cancel signals N5′).

The memory 5 is used, on one hand, as a work area and a program storage area by the microprocessor 4 and, on the other hand, as an area for storing the abnormality history information N3 from the motor driver IC 1.

In the optical disc drive apparatus of this embodiment configured as described above, the driver circuits 11 to 15 included in the motor driver IC 1 are individually furnished with abnormality protectors 11a to 15a so that, if an abnormality occurs in any of the driver circuits 11 to 15, the corresponding one of the abnormality protectors 11a to 15a limits or stops the output of that driver circuit and then outputs an abnormality detection flag N4 to indicate the abnormal status.

In addition, of all the driver circuits 11 to 15, those belonging to the first group, namely the spindle motor driver circuit 11, the sled motor driver circuit 12, the focus servo driver circuit 13, and the tracking servo driver circuit 14, are each so configured as to limit or stop their output not only if an abnormality occurs in themselves but also if an abnormality occurs in any other driver circuit as recognized based on the abnormality detection flag N4 outputted from that driver circuit.

With this configuration, when an abnormality occurs in one driver circuit, protection is immediately activated not only for that driver circuit but also for the other driver circuits, and thus well before an abnormality actually occurs in any of these, thereby achieving precautionary protection. Thus, the motor driver IC 1 of this embodiment operates with improved safety and reliability as a result of coordinated protection against an abnormality among the multiple-channel driver circuits.

In the motor driver IC 1 of this embodiment, the above-described coordinated abnormality protection among the driver circuits 11 to 15 (i.e., the coordinated abnormality protection that the motor driver IC 1 performs by itself based on the abnormality detection flags N4 without being controlled by the microprocessor 4) can be enabled and disabled according to a control signal (unillustrated) from outside the IC (e.g., from the microprocessor 4). With this configuration, the user can freely choose whether, on occurrence of an abnormality, to let the motor driver IC 1 perform abnormality protection by itself or to make it do it according to a shut-off signal N5 from the microprocessor 4.

On the other hand, in the motor driver IC 1 of this embodiment, the loading motor driver circuit 15, which alone is classified into the second group, is so configured as to limit or stop its output only if an abnormality occurs in itself, irrespective of an abnormality detection flag N4 outputted from whichever of the driver circuits 11 to 14 is suffering an abnormality (or a shut-off signal N5 outputted from the microprocessor 4 in case of an abnormality in any of the driver circuits 11 to 14). With this configuration, even if an abnormality occurs in any of the driver circuits 11 to 14, unless an abnormality occurs in the loading motor driver circuit 15, the optical disc remains ready to be loaded (or unloaded).

Thus, with the optical disc drive apparatus of this embodiment, if an abnormality occurs in any of the driver circuits 11 to 14, all their outputs are limited or stopped—allowing the apparatus to operate with improved safety and reliability, while the output of the loading motor driver circuit 15 is maintained—allowing the user to unload an optical disc quickly to minimize the risk of the optical disc being damaged.

Moreover, in the optical disc drive apparatus of this embodiment, whenever the microprocessor 4 receives an abnormality detection flag N4, it stores in the memory 5 abnormality history information N3 with regard to the motor driver IC 1. Notifying the microprocessor 4 whenever the motor driver IC 1 is in abnormal state to store the abnormality history information N3 in this way contributes to improved techniques and safety in the future.

Moreover, in the optical disc drive apparatus of this embodiment, whenever the microprocessor 4 receives an abnormality detection flag N4, it indicates the abnormal status of the motor driver IC 1 visually on a display and/or audibly from a loudspeaker (neither is illustrated). With this configuration, the user can recognize the abnormal status of the motor driver IC 1 readily, and can thus perform a recovery quickly. This contributes to enhance the safety and reliability of the apparatus.

Now, the configuration and operation of the abnormality protector 11a, as the representative of the abnormality protectors 11a to 15a, will be described in detail.

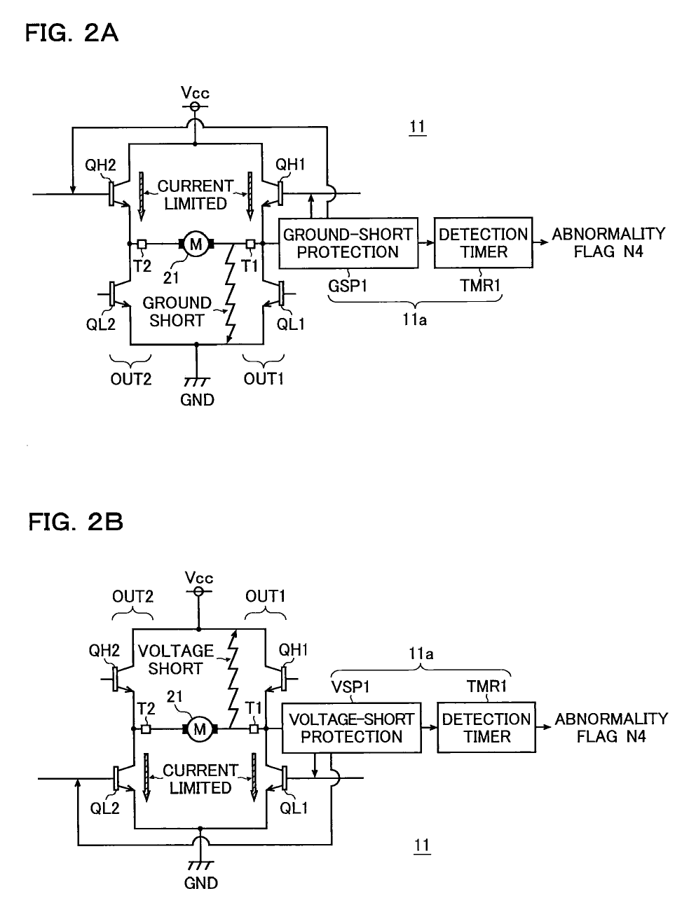

FIGS. 2A and 2B are block diagrams showing examples of the configuration of the abnormality protector 11a. Whereas the configuration shown in FIG. 2A includes a ground-short protection circuit GSP1 (a circuit protecting against short-circuiting to ground), the configuration shown in FIG. 2B includes a voltage-short protection circuit VSP1 (a circuit protecting against short-circuiting to a supplied voltage).

As shown in FIGS. 2A and 2B, the spindle motor driver circuit 11 has two totem-pole-configuration output circuits OUT1 and OUT2 connected one to each end of the spindle motor 21. More specifically, the voltages at both ends of the spindle motor 21 are freely controlled by a pair of class-B push-pull amplifiers having in their output stage the just-mentioned output circuits OUT1 and OUT2 respectively; that is, a BTL (bridged tied load) configuration is adopted.

The output circuit OUT1 has an upper switch QH1 and a lower switch QL1 (both NPN-type bipolar transistors) connected in series between two different supplied voltages (Vcc and GND). The node between the two switches branches to an external terminal T1 to which one end of the spindle motor 21 is connected.

The output circuit OUT2 has an upper switch QH2 and a lower switch QL2 (both NPN-type bipolar transistors) connected in series between the two different supplied voltages (Vcc and GND). The node between the two switches branches to an external terminal T2 to which the other end of the spindle motor 21 is connected.

The spindle motor driver circuit 11 shown in FIG. 2A includes, as part of the abnormality protector 11a, a ground-short protection circuit GSP1 that restricts not only the output current of the upper switch QH1 of the output circuit OUT1 but also the output current of the upper switch QH2 of the output circuit OUT2 if a ground short (accidental short-circuiting to GND or any other lower-potential point) occurs at the external terminal T1 of the output circuit OUT1. Although omitted in FIG. 2A, the spindle motor driver circuit 11 further has, connected to the external terminal T2, another ground-short protection circuit configured similarly as described just above.

On the other hand, the spindle motor driver circuit 11 shown in FIG. 2B includes, as part of the abnormality protector 11a, a voltage-short protection circuit VSP1 that restricts not only the output current of the lower switch QL1 of the output circuit OUT1 but also the output current of the lower switch QL2 of the output circuit OUT2 if a voltage short (accidental short-circuiting to Vcc or any other higher-potential point) occurs at the external terminal T1 of the output circuit OUT1. Although omitted in FIG. 2B, the spindle motor driver circuit 11 has another voltage-short protection circuit, configured similarly as described just above, connected to the external terminal T2.

With the configurations shown in FIG. 2A and 2B, where, on occurrence of a ground short or voltage short at one of the external terminals T1 and T2, not only the current through the abnormal-side output circuit but also the current through the normal-side output circuit is limited as described above, it is possible not only to reduce the short-circuiting overcurrent that flows through the abnormal-side output circuit (the through current that flows between the two different supplied voltages) but also to reduce the unintended drive current that flows through the normal side output circuit.

Thus, with the spindle motor driver circuit 11 of this embodiment, even if the driving of the load is continued with a ground short or voltage short occurring at the external terminal T1 or T2, there is less risk of the spindle motor 21, the circuit board, or the optical disc being damaged.

In addition, as shown in FIGS. 2A and 2B, the abnormality protector 11a included in the spindle motor driver circuit 11 also includes an abnormality detection timer circuit TMR1 that permits the output of the previously mentioned abnormality detection flag N4 only if no recovery from a ground short or voltage short at the external terminal T1 or T2 is made within a predetermined period.

With this configuration, whereas protection against an abnormality at the external terminal T1 or T2 (the limiting of the currents through the output circuits OUT1 and OUT2) is performed immediately, the outputting of the abnormality detection flag N4 is effected only if no recovery from a ground short or voltage short at the external terminal T1 or T2 is made within a predetermined period.

Thus, with the spindle motor driver circuit 11 of this embodiment, a simple occurrence of a temporary ground short or voltage short at the external terminal T1 or T2 does not provoke coordinated abnormality protection among the driver circuits, or cause the microprocessor 4 to be notified of abnormal state (which would then cause the microprocessor 4 to feed a shut-off signal N5 to the motor driver IC 1). This allows the apparatus to operate with enhanced stability.

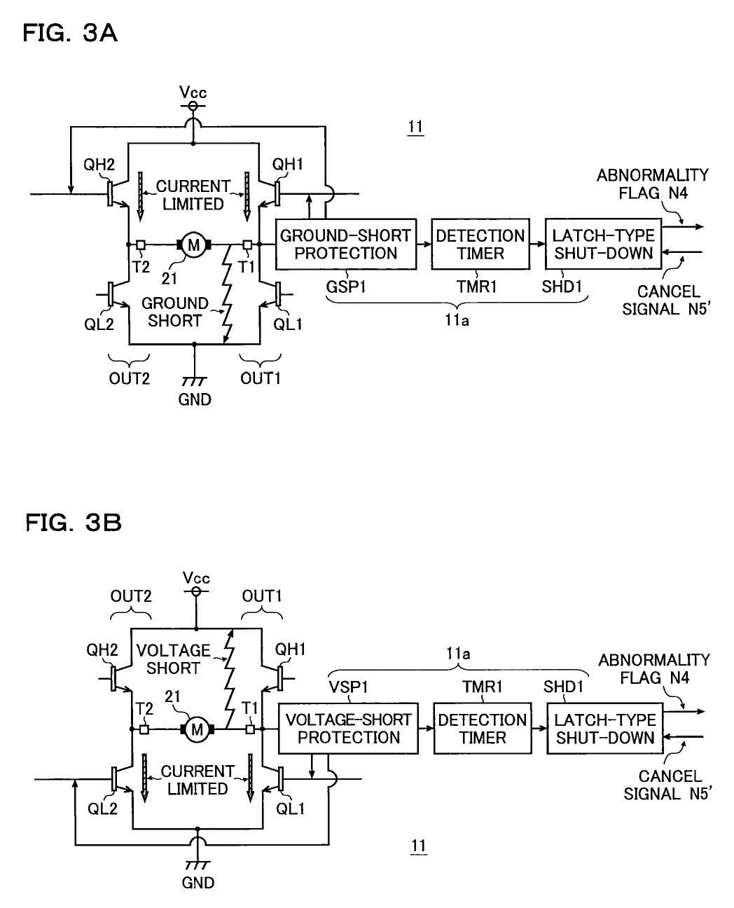

The abnormality protector 1la may be configured in any other manner than specifically described above. For example, as shown in FIGS. 3A and 3B, the abnormality protector Ha may further include a latch-type shut-down circuit SHD1, in which case it operates as follows: if a ground short or voltage short occurs at the external terminal T1 or T2, the limiting of the currents through the output circuits OUT1 and OUT2 is performed immediately; in addition, only if no recovery from the abnormality status is made within a predetermined period, the driving of the output circuits OUT1 and OUT2 is shut down and an abnormality detection flag N4 is outputted; thereafter, the driving of the output circuits OUT1 and OUT2 remains stopped until a cancel signal N5′ is received from outside the apparatus (e.g., from the microprocessor 4).

Next, the configuration and operation of the ground-short protection circuit GSP1 will be described in detail.

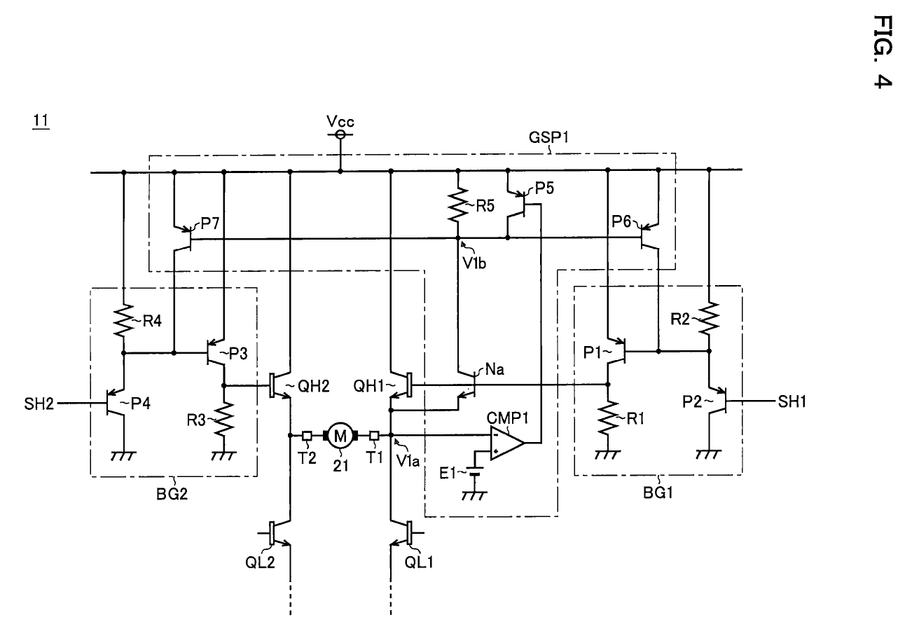

FIG. 4 is a circuit diagram showing a specific example of the ground-short protection circuit GSP1.

As shown in FIG. 4, in the spindle motor driver circuit 11 of this embodiment, the base current of the upper switch QH1 is generated by a base current generating circuit BG1, which includes resistors R1 and R2 and PNP-type bipolar transistors P1 and P2; the base current of the upper switch QH2 is generated by a base current generating circuit BG2, which includes resistors R3 and R4 and PNP-type bipolar transistors P3 and P4.

The ground-short protection circuit GSP1 itself includes a resistor R5, PNP-type bipolar transistors P5 to P7, an NPN-type bipolar transistor Na, a comparator CMP1, and a direct-current voltage source E1.

The interconnection in the base current generating circuit BG1 is as follows. The emitter of the transistor P1 is connected to the Vcc line. The collector of the transistor P1 is connected via the resistor R1 to the GND line, and is also connected to the base of the upper switch QH1. The base of the transistor P1 is connected via the resistor R2 to the Vcc line, and is also connected to the emitter of the transistor P2. The collector of the transistor P2 is connected to the GND line. The base of the transistor P2 is connected to a point to which a drive signal SH1 is applied.

The interconnection in the base current generating circuit BG2 is as follows. The emitter of the transistor P3 is connected to the Vcc line. The collector of the transistor P3 is connected via the resistor R3 to the GND line, and is also connected to the base of the upper switch QH2. The base of the transistor P3 is connected via the resistor R4 to the Vcc line, and is also connected to the emitter of the transistor P4. The collector of the transistor P4 is connected to the GND line. The collector of the transistor P4 is connected to the GND line. The base of the transistor P4 is connected to a point to which a drive signal SH2 is applied.

The interconnection in the ground-short protection circuit GSP1 is as follows. The collector of the transistor Na is connected via the resistor R5 to the Vcc line. The emitter of the transistor Na is connected to the emitter of the upper switch QH1. The base of the transistor Na is connected to the base of the upper switch QH1.

The inverting input terminal (−) of the comparator CMP1 is connected to the external terminal T1. The non-inverting input terminal (+) of the comparator CMP1 is connected to the positive end of the direct-current voltage source E1. The negative end of the direct-current voltage source E1 is connected to the GND line. The output terminal of the comparator CMP1 is connected to the base of the transistor P5.

The emitters of the transistors P5 to P7 are connected to the Vcc line. The collector of the transistor P5, the base of the transistor P6, and the base of the transistor P7 are all connected to the collector of the transistor Na. The collector of the transistor P6 is connected to the base of the transistor P1. The collector of the transistor P7 is connected to the base of the transistor P3.

Now, the operation of the ground-short protection circuit GSP1 configured as described above will be described.

When a ground short occurs at the external terminal T1, the voltage Via at one end of the spindle motor 21 falls below a predetermined threshold voltage (the voltage produced by the direct-current voltage source E1), and this causes the comparator CMP1 to turn its output logic level from low to high. As a result, the transistor P5 turns from on to off, and thereby cancels the bypass via the resistor R5.

Thus, thereafter, as the monitoring current flowing through the resistor R5 (the monitoring current behaving equivalently to the short-circuiting current flowing through the upper switch QH1) increases, the voltage V1b at one end of the resistor R5 decreases, and thus the conductances through the transistors P6 and P7 increase (i.e., the base potentials of the transistors P1 and P3 are shifted to the high side).

Consequently, as the monitoring current flowing through the resistor R5 increases, the conductances through the transistors P1 and P3 decrease, and hence the conductances through the upper switches QH1 to QH2 decrease. Thus, the short-circuiting current and drive current flowing through these switches QH1 to QH2 are limited or shut off.

As described above, the ground-short protection circuit GSP1 in this embodiment recognizes a ground short and limits the output currents of both the upper switches QH1 and QH2 if the voltage V1a at the external terminal T1 is below the predetermined level and in addition if the current flowing through the upper switch QH1 connected to the external terminal T1 is above a predetermined level (the level of current supposed to flow there normally).

Although omitted in FIG. 4, the spindle motor driver circuit 11 has, in its external terminal T2 side, another ground-short protection circuit configured similarly as described above and operating similarly as described above.

Although unillustrated in FIG. 4, the voltage-short protection circuits VSP1 shown in FIGS. 2B and 3B (and those provided in the other side) are configured on the same principles as described above; specifically, they are so configured as to recognize a voltage short and limit the output currents of both the lower switches QL1 and QL2 if the voltage at an external terminal is above a predetermined level and in addition if the current flowing through the lower switch connected to that external terminal is above a predetermined level (the level of current supposed to flow there normally).

With this configuration, it is possible to realize ground-short and voltage-short protection circuits with an extremely simple circuit configuration.

Incidentally, an abnormality detection flag N4, described previously, can be generated, for example, based on the result of checking whether the voltage V1b at one end of the resistor R5 has remained below a predetermined level for a predetermined period.

The embodiment described above deals with a case where the present invention is applied to a motor driver IC incorporated in an optical disc drive apparatus; this, however, is not meant to limit the application of the invention in any way; the invention finds wide application in any other types of load driving apparatuses and electric appliances.

The present invention may be practiced in any other manner than specifically described above as an embodiment, with any modification or variation made within the sprit of the invention. For example, although FIG. 1 shows an example in which shut-off signals N5 are fed from the microprocessor 4 to the motor driver IC 1, this is not meant to limit in any way how the invention should be practiced; instead, for example, the motor driver IC 1 may be controlled in a similar manner via control signals N1 to the DSP 3.

In terms of benefits, the present invention helps realize a load driving apparatus that is provided with a plurality of driver circuits for supplying drive currents individually to a plurality of loads but that nevertheless operates with improved safety and reliability as a result of coordinated protection against an abnormality among the individual driver circuits, and to provide an electric appliance (e.g., disc drive apparatus) incorporating such a load driving apparatus.

In terms of industrial applicability, the present invention is useful in enhancing the safety and reliability of electric appliances incorporating an optical disc drive apparatus for playing back optical discs such as DVDs (digital versatile discs), CDs (compact discs), and MDs (minidiscs)—for example, car navigation systems, car audio systems, and portable navigation systems.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A load driving apparatus comprising:
a plurality of driver circuits supplying drive currents individually to a plurality of loads,
wherein, of the plurality of driver circuits, at least one driver circuit limits or stops an output thereof not only if an abnormality occurs in that driver circuit itself but also if an abnormality occurs in any other driver circuit.

2. The load driving apparatus of claim 1,
wherein the plurality of driver circuits are classified into a first group of driver circuits concerned with driving of a medium and of a head and a second groups of driver circuits concerned with loading of the medium, and
wherein any driver circuit belonging to the second group limits or stops an output thereof only if an abnormality occurs in that driver circuit itself.

3. The load driving apparatus of claim 1,
wherein the plurality of driver circuits each comprise:
a plurality of totem-pole-configuration output circuits each having an upper switch and a lower switch connected in series between two different supplied voltages, a node between the upper and lower switches branching to an external terminal to which a corresponding one of the loads is connected; and
a ground-short protection circuit restricting output currents of upper switches of all the output circuits if a ground short occurs at the external terminal of any one of the plurality of output circuits.

4. The load driving apparatus of claim 3,
wherein the ground-short protection circuit recognizes the ground short if the voltage at that external terminal is below a predetermined level and in addition if a current flowing through the upper switch connected to that external terminal is above a predetermined level.

5. The load driving apparatus of claim 1,
wherein the plurality of driver circuits each comprise:
a plurality of totem-pole-configuration output circuits each having an upper switch and a lower switch connected in series between two different supplied voltages, a node between the upper and lower switches branching to an external terminal to which a corresponding one of the loads is connected; and
a voltage-short protection circuit restricting output currents of lower switches of all the output circuits if a voltage short occurs at the external terminal of any one of the plurality of output circuits.

6. The load driving apparatus of claim 5,
wherein the voltage-short protection circuit recognizes the voltage short if the voltage at that external terminal is above a predetermined level and in addition if a current flowing through the lower switch connected to that external terminal is above a predetermined level.

7. The load driving apparatus of claim 1,
wherein coordinated abnormality protection among the plurality of driver circuits is enabled and disabled according to a control signal from outside the apparatus.

8. The load driving apparatus of claim 1,
wherein, of the plurality of driver circuits, at least one driver circuit outputs, if an abnormality occurs in itself, an abnormality detection signal indicating occurrence of the abnormality.

9. An electric appliance comprising:
a load driving apparatus;
a plurality of loads supplied with drive currents from the load driving apparatus; and
a microprocessor receiving an abnormality detection signal from the load driving apparatus,
wherein the load driving apparatus comprises:
a plurality of driver circuits supplying drive currents individually to a plurality of loads,
wherein, of the plurality of driver circuits, at least one driver circuit limits or stops an output thereof not only if an abnormality occurs in that driver circuit itself but also if an abnormality occurs in any other driver circuit.
wherein, of the plurality of driver circuits, at least one driver circuit outputs, if an abnormality occurs in itself, the abnormality detection signal indicating occurrence of the abnormality to the microprocessor.

10. The electric appliance of claim 9,
wherein, on receiving the abnormality detection signal, the microprocessor stores abnormality history information in a memory.

11. The electric appliance of claim 9,
wherein, on receiving the abnormality detection signal, the microprocessor indicate the occurrence of the abnormality on a display and/or from a loudspeaker.
